(19) United States
(12) Patent Application Publication
(10) Pub. No.: US 2003/0175192 A1
(43) Pub. Date: Sep. 18, 2003

(54) SOx trap for enhancing NOx trap performance and methods of making and using the same

(75) Inventors: Zhicheng Hu, Edison, NJ (US); Patrick L. Burk, Freehold, NJ (US); Shau-Lin F. Chen, Piscataway, NJ (US)

Correspondence Address: Chief Patent Counsel, Engelhard Corporation, 101 Wood Avenue, P.O. Box 770, Iselin, NJ, 08830-0770, US

(73) Assignee: ENGELHARD CORPORATION

(21) Appl. No.: 10/357,773

(22) Filed: Feb. 4, 2003

Related U.S. Application Data
(63) Continuation-in-part of application No. 09/771,281, filed on Jan. 26, 2001, now abandoned.

(51) Int. Cl. B01D 53/60

(52) U.S. Cl. 423/239.1; 502/339; 502/302

(57) ABSTRACT

The present invention relates to a method and a catalyst composite useful for reducing contaminants in exhaust gas streams containing sulfur oxide contaminants. The method for removing NOx and SOx contaminants from a gaseous stream comprises providing a catalyst composite having a downstream section and an upstream section. The downstream section comprises a first support, a first platinum component, and a NOx sorbent component. The upstream section comprises a second support, a second platinum component, and a SOx sorbent component selected from the group consisting of oxides of Mg, Sr, and Ba. In a sorbing period, a lean gaseous stream comprising NOx and SOx is passed through the upstream section to sorb at least some of the SOx contaminants. The downstream section sorbs and abates the NOx in the gaseous stream. In a SOx desorbing period, the temperature of the gaseous stream is raised to within a desorbing temperature range to thereby desorb and abate at least some of the SOx contaminants in the upstream section. The desorbing temperature range is sufficiently high such that the SOx contaminants are substantially not sorbed in the downstream section. In a NOx desorbing period, the exhaust gas is converted from a lean stream to a rich stream to desorb and reduce at least some of the NOx contaminants from the downstream section.

This is a continuation-in-part application of parent application Ser. No. 09/771,281, filed Jan. 26, 2001.

### BACKGROUND OF THE INVENTION

1. Field of the Invention

The present invention relates to a method and a catalyst composite useful for reducing contaminants in exhaust gas streams, especially gaseous streams containing sulfur oxide contaminants. More specifically, the present invention is concerned with a method for removing NOx contaminants from a SOx containing gaseous stream comprising providing a catalyst composite having a downstream section and an upstream section. The downstream section comprises a first support, a first platinum component, and a NOx sorbent component. The upstream section comprises a second support, a second platinum component, and a SOx sorbent component selected from the group consisting of oxides of Mg, Sr, and Ba. In a sorbing period, a lean gaseous stream comprising NOx and SOx is passed within a sorbing temperature range through the upstream section to sorb at least some of the SOx contaminants and thereby provide a SOx depleted gaseous stream exiting the upstream section and entering the downstream section. The downstream section sorbs and abates the NOx in the gaseous stream and thereby provides a NOx depleted gaseous stream exiting the downstream section. In a SOx desorbing period, the lean gaseous stream is converted to a rich gaseous stream and the temperature of the gaseous stream is raised to within a desorbing temperature range to thereby desorb and abate at least some of the SOx contaminants in the upstream section and thereby provide a SOx enriched gaseous stream exiting the upstream section and entering the downstream section. The desorbing temperature range is sufficiently high such that the SOx contaminants are substantially not sorbed in the downstream section.

2. Related Art

Three-way conversion catalysts (“TWC”) have utility in a number of fields including the abatement of nitrogen oxides (“NOx”), carbon monoxide (“CO”), and hydrocarbon (“HC”) pollutants from internal combustion engines, such as automobile and other gasoline-fueled engines. Three-way conversion catalysts are polyfunctional because they have the ability to substantially simultaneously catalyze the oxidation of hydrocarbons and carbon monoxide and the reduction of nitrogen oxides. Emissions standards for nitrogen oxides, carbon monoxide, and unburned hydrocarbon contaminants have been set by various government agencies and must be met by new automobiles. In order to meet such standards, catalytic converters containing a TWC catalyst are located in the exhaust gas line of internal combustion engines. The catalysts promote the oxidation by oxygen in the exhaust gas of the unburned hydrocarbons and carbon monoxide and the reduction of nitrogen oxides to nitrogen. For example, it is known to treat the exhaust of engines with a catalyst/NOx sorbent which stores NOx during periods of lean (oxygen-rich) operation, and releases the stored NOx during the rich (relatively fuel-rich) periods of operation. During periods of rich operation, the catalyst component of the catalyst/NOx sorbent promotes the reduction of NOx to nitrogen by reaction of NOx (including NOx released from the NOx sorbent) with HC, CO, and/or hydrogen present in the exhaust.

TWC catalysts exhibiting good activity and long life comprise one or more platinum group metals, e.g., platinum, palladium, rhodium, ruthenium, and iridium. These catalysts are employed with a high surface area, refractory oxide support such as a high surface area alumina coating. The support is carried on a suitable carrier or substrate such as a monolithic carrier comprising a refractory ceramic or metal honeycomb structure, or refractory particles such as spheres or short, extruded segments of a suitable refractory material. The supported catalyst is generally used with a NOx storage (sorbent) component including alkaline earth metal oxides, such as oxides of Ca, Sr and Ba, alkali metal oxides such as oxides of K, Na, Li and Cs, and rare earth metal oxides such as oxides of Ce, La, Pr and Nd, see U.S. Pat. No. 5,473,887.

Sulfur oxide (“SOx”) contaminants present in an exhaust gaseous stream tend to poison and thereby inactivate NOx adsorber catalysts. SOx is a particular problem because it is generated by the oxidation of sulfur compound impurities often found in gasoline and diesel fuel. NOx adsorber catalysts employing NOx storage components tend to suffer from loss of long-term activity because of SOx poisoning of the NOx traps. NOx trap components also trap SOx and form very stable sulfates, which require extreme conditions and a high fuel penalty to regenerate the trapping capacity of the NOx storage component. A guard or filter (e.g., alumina) may be placed before the TWC catalyst to protect the catalyst from SOx but these guards or filters often become saturated with SOx.

High surface refractory metal oxides are often employed as a support for many of the catalytic components. For example, high surface area alumina materials, also referred to as “gamma alumina” or “activated alumina” typically exhibit a BET (Brunauer, Emmett, and Teller) surface area in excess of 60 square meters per gram (“m2/g”), and often up to about 200 m2/g or more. Such activated alumina is usually a mixture of the gamma and delta phases of alumina, but may also contain substantial amounts of eta, kappa and theta alumina phases. Refractory metal oxides other than activated alumina may be utilized as a support for at least some of the catalytic components in a given catalyst. For example, bulk ceria, zirconia, alpha alumina and other materials are known for such use. Although many of these materials have a lower BET surface area than activated alumina, that disadvantage tends to be offset by the greater durability of the resulting catalyst.

Exhaust gas temperatures can reach 1000° C. in a moving vehicle and such elevated temperatures can cause activated alumina, or other support material, to undergo thermal degradation with accompanying volume shrinkage especially in the presence of steam. During this degradation, the catalytic metal becomes occluded in the shrunken support medium with a loss of exposed catalyst surface area and a corresponding decrease in catalytic activity. U.S. Pat. No. 4,171,288 discloses a method to stabilize alumina supports against such thermal degradation by the use of materials such as zirconia, titania, alkaline earth metal oxides such as baria, calcia, or strontia, or rare earth metal oxides such as ceria, lanthana, and mixtures of two or more rare earth metal oxides.

U.S. Pat. Nos. 4,714,694, 4,727,052, and 4,708,946 disclose the use of bulk cerium oxide (ceria) to provide a refractory oxide support for platinum group metals other than rhodium. Highly dispersed, small crystallites of platinum on the ceria particles may be formed and stabilized by impregnation with a solution of an aluminum compound followed by calcination.

U.S. Pat. No. 3,993,572 discloses catalysts for promoting selective oxidation and reduction reactions. The catalyst contains platinum group metal, rare earth metal (ceria) and alumina components, which may be supported on a relatively inert carrier such as a honeycomb.

U.S. Pat. No. 4,714,694 discloses a method of making a material which includes impregnating bulk ceria or a bulk ceria precursor with an aluminum compound and calcining the impregnated ceria to provide an aluminum stabilized ceria.

U.S. Pat. No. 4,808,564 discloses a catalyst for the purification of exhaust gases having improved durability which comprises a support substrate, a catalyst carrier layer formed on the support substrate and catalyst ingredients carried on the catalyst carrier layer. The catalyst carrier layer comprises oxides of lanthanum and cerium in which the molar fraction of lanthanum atoms to total rare earth atoms is 0.05 to 0.20 and the ratio of the number of the total rare earth atoms to the number of aluminum atoms is 0.05 to 0.25.

U.S. Pat. No. 4,367,162 discloses a three-way catalyst system which comprises a carrier having a substructure of refractory material in the form of a honeycomb structure and a porous layer of a powder formed on the surface thereof selected from the group consisting of a powder of zirconium oxide and a mixed powder of zirconium oxide powder with at least powder selected from the group consisting of alumina, alumina-magnesia spinel and cerium oxide, and a catalyst ingredient supported thereon consisting of cerium oxide and a metal selected from the group consisting of platinum, palladium, and mixtures thereof.

U.S. Pat. No. 4,438,219 discloses an alumina catalyst, stable at high temperatures, for use on a substrate. The stabilizing material is derived from barium, silicon, rare earth metals, alkali and alkaline earth metals, boron, thorium, hafnium, and zirconium. Barium oxide, silicon dioxide, and rare earth oxides including lanthanum, cerium, praseodymium, and neodymium are preferred. Contacting the stabilizing material with a calcined alumina film permits the calcined alumina film to retain a high surface area at higher temperatures.

U.S. Pat. Nos. 4,476,246, 4,591,578 and 4,591,580 disclose three-way catalyst compositions comprising alumina, ceria, an alkali metal oxide promoter, and Noble metals. U.S. Pat. Nos. 3,993,572 and 4,157,316 describe attempts to improve the catalyst efficiency of Pt/Rh based TWC systems by incorporating a variety of metal oxides, e.g., rare earth metal oxides such as ceria and base metal oxides such as nickel oxides. U.S. Pat. No. 4,591,518 discloses a catalyst comprising an alumina support with catalytic components consisting essentially of a lanthana component, ceria, an alkali metal oxide, and a platinum group metal. U.S. Pat. No. 4,591,580 discloses an alumina supported platinum group metal catalyst modified to include support stabilization by lanthana or lanthana rich rare earth oxides, double promotion by ceria and alkali metal oxides and optionally nickel oxide.

U.S. Pat. No. 4,624,940 discloses palladium containing catalyst compositions useful for high temperature applications. The combination of lanthanum and barium is found to provide a superior hydrothermal stabilization of alumina, which supports the catalytic component, palladium. Thus, the palladium metal expulsion from the alumina due to phase transformation to encounter drastic sintering upon high temperature exposure is avoided. The use of particulate bulk metal oxide enhances catalytic activities. The bulk metal oxide consists of primarily ceria containing and/or ceria-zirconia containing particles. These particulate bulk metal oxides do not readily react with the stabilized alumina particles, thus, provide the catalytically promoting effect.

U.S. Pat. No. 4,780,447 discloses a catalyst capable of controlling HC, CO and NOx as well as H2S in emissions from the tailpipe of catalytic converter equipped automobiles. The use of nickel oxides and/or iron oxides is known as a H2S gettering of compound.

U.S. Pat. No. 4,294,726 discloses a TWC catalyst composition containing platinum and rhodium obtained by impregnating a gamma alumina carrier material with an aqueous solution of cerium, zirconium and iron salts or mixing the alumina with oxides of, respectively, cerium, zirconium and iron, and then calcining the material at 500° C. to 700° C. in air after which the material is impregnated with an aqueous solution of a salt of platinum and a salt of rhodium dried and subsequently treated in a hydrogen-containing gas at a temperature of 250° C.-650° C. The alumina may be thermally stabilized with calcium, strontium, magnesium or barium compounds. The ceria-zirconia-iron oxide treatment is followed by impregnating the treated carrier material with aqueous salts of platinum and rhodium and then calcining the impregnated material.

U.S. Pat. No. 4,965,243 discloses a method to improve the thermal stability of a TWC catalyst containing precious metals by incorporating a barium compound and a zirconium compound together with ceria and alumina to form a catalytic moiety to enhance stability of the alumina washcoat upon exposure to high temperature.

J01210032 and AU-615721 disclose a catalytic composition comprising palladium, rhodium, active alumina, a cerium compound, a strontium compound and a zirconium compound. These patents suggests the utility of alkaline earth metals in combination with ceria, zirconia to form a thermally stable alumina supported palladium containing washcoat.

U.S. Pat. No 4,504,598 discloses a process for producing a high temperature resistant TWC catalyst. The process includes forming an aqueous slurry of particles of gamma or activated alumina and impregnating the alumina with soluble salts of selected metals including cerium, zirconium, at least one of iron and nickel and at least one of platinum, palladium and rhodium and, optionally, at least one of neodymium, lanthanum, and praseodymium. The impregnated alumina is calcined at 600° C. and then dispersed in water to prepare a slurry which is coated on a honeycomb carrier and dried to obtain a finished catalyst.

U.S. Pat. Nos. 3,787,560, 3,676,370, 3,552,913, 3,545,917, 3,524,721 and 3,899,444 disclose the use of neodymium oxide for use in reducing nitric oxide in exhaust gases of internal combustion engines. U.S. Pat. No. 3,899,444 in particular discloses that rare earth metals of the lanthanide series are useful with alumina to form an activated stabilized catalyst support when calcined at elevated temperatures. Such rare earth metals are disclosed to include lanthanum, ceria, cerium, praseodymium, neodymium and others.

U.S. Pat. No. 5,792,436 discloses a method for removing nitrogen oxides, sulfur oxides, and phosphorus oxides from a lean gaseous stream. The method comprises (a) passing the gaseous stream through a catalyzed trap comprising a regenerable sorbent material and an oxidation catalyst and sorbing the sorbable components into the sorbent material, (b) introducing a combustible component into the gaseous stream upstream of the catalyzed trap member and combusting the combustible component in the presence of the oxidation catalyst to thermally desorb the sorbable component from the sorbent material, and (c) passing the sorbable component-depleted stream to a catalytic treatment zone for the abatement of the pollutants and by-passing the sorbable component-enriched stream around the catalytic treatment zone.

TWC catalyst systems comprising a carrier and two or more layers of refractory oxide are disclosed. Japanese Patent Publication No. 145381/1975 discloses a catalyst-supported structure for purifying exhaust gases comprising a thermally insulating ceramic carrier and at least two layers of catalyst containing alumina or zirconia, the catalysts containing alumina or zirconia layers being different from each other.

Japanese Patent Publication No. 105240/1982 discloses a catalyst for purifying exhaust gases containing at least two carrier layers of a refractory metal oxide, each containing a different platinum-group metal. A layer of a refractory metal oxide free from the platinum-group metal is positioned between the carrier layers and/or on the outside of these carrier layers.

Japanese Patent Publication No. 52530/1984 discloses a catalyst having a first porous carrier layer composed of an inorganic substrate and a heat-resistant Noble metal-type catalyst deposited on the surface of the substrate and a second heat-resistant non-porous granular carrier layer having deposited thereon a Noble metal-type catalyst. The second carrier layer is formed on the surface of the first carrier layer and has resistance to the catalyst poison.

Japanese Patent Publication No. 127649/1984 discloses a catalyst for purifying exhaust gases comprising an inorganic carrier substrate such as cordierite, an alumina layer formed on the surface of the substrate and having deposited thereon a rare earth metal, such as lanthanum and cerium, and platinum or palladium, and a second layer formed on the first alumina-based layer and having deposited thereon a base metal such as iron or nickel and a rare earth metal such as lanthanum or rhodium.

Japanese Patent Publication No. 19036/1985 discloses a catalyst for purifying exhaust gases having an enhanced ability to remove carbon monoxide at low temperatures. The catalyst comprises a substrate composed of cordierite and two layers of active alumina laminated to the surface of the substrate. The lower alumina layer contains platinum or vanadium deposited thereon, and the upper alumina layer contains rhodium and platinum, or rhodium and palladium, deposited thereon.

Japanese Patent Publication No. 31828/1985 discloses a catalyst for purifying exhaust gases comprising a honeycomb carrier and a Noble metal having a catalytic action for purifying exhaust gases. The carrier is covered with an inside and an outside alumina layer, the inside layer having more Noble metal adsorbed thereon than the outside layer.

Japanese Patent Publication No. 232253/1985 discloses a monolithic catalyst for purifying exhaust gases in the shape of a pillar and comprising a number of cells disposed from an exhaust gas inlet side toward an exhaust gas outlet side. An alumina layer is formed on the inner wall surface of each of the cells and catalyst ingredients are deposited on the alumina layer. The alumina layer consists of a first alumina layer on the inside and a second alumina layer on the surface side, the first alumina layer having palladium and neodymium, and the second alumina layer having platinum and rhodium.

Japanese Kokai 71538/87 discloses a catalyst layer supported on a catalyst carrier and containing one catalyst component selected from the group consisting of platinum, palladium and rhodium. An alumina coat layer is provided on the catalyst layer. The coat layer contains one oxide selected from the group consisting of cerium oxide, nickel oxide, molybdenum oxide, iron oxide and at least one oxide of lanthanum and neodymium (1-10% by wt.).

U.S. Pat. Nos. 3,956,188 and 4,021,185 disclose a catalyst composition having (a) a catalytically active, calcined composite of alumina, a rare earth metal oxide and a metal oxide selected from the group consisting of an oxide of chromium, tungsten, a group IVB metal and mixtures thereof and (b) a catalytically effective amount of a platinum group metal added thereto after calcination of the composite. The rare earth metals include cerium, lanthanum and neodymium.

U.S. Pat. No. 4,806,519 discloses a two layer catalyst structure having alumina, ceria and platinum on the inner layer and aluminum, zirconium and rhodium on the outer layer.

JP-88-240947 discloses a catalyst composite which includes an alumina layer containing ceria, ceria-doped alumina and at least one component selected from the group of platinum, palladium and rhodium. A second layer contains lanthanum-doped alumina, praseodymium-stabilized zirconium, and lanthanum oxide and at least one component selected from the group of palladium and rhodium. The two layers are placed on a catalyst carrier separately to form a catalyst for exhaust gas purification.

Japanese Patent J-63-205141-A discloses a layered automotive catalyst in which the bottom layer comprises platinum or platinum and rhodium dispersed on an alumina support containing rare earth oxides, and a top coat, which comprises palladium and rhodium dispersed on a support comprising alumina, zirconia and rare earth oxides.

Japanese Patent J-63-077544-A discloses a layered automotive catalyst having a first layer comprising palladium dispersed on a support comprising alumina, lanthana and other rare earth oxides and a second coat comprising rhodium dispersed on a support comprising alumina, zirconia, lanthana and rare earth oxides.

Japanese Patent J-63-007895-A discloses an exhaust gas catalyst comprising two catalytic components. One component comprises platinum dispersed on a refractory inorganic oxide support and a second component comprises palladium and rhodium dispersed on a refractory inorganic oxide support.

U.S. Pat. No. 4,587,231 discloses a method of producing a monolithic three-way catalyst for the purification of exhaust gases. A mixed oxide coating is applied to a monolithic carrier by treating the carrier with a coating slip in which an active alumina powder containing cerium oxide is dispersed together with a ceria powder and then baking the treated carrier. Platinum, rhodium and/or palladium are then deposited on the oxide coating by a thermal decomposition. Optionally, a zirconia powder may be added to the coating slip.

U.S. Pat. No. 4,134,860 relates to catalyst compositions that can contain platinum group metals, base metals, rare earth metals and refractory supports. The composition can be deposited on a relatively inert carrier such as a honeycomb. U.S. Pat. No. 4,923,842 discloses a catalytic composition for treating exhaust gases comprising a first support having dispersed thereon at least one oxygen storage component and at least one Noble metal component, and having dispersed immediately thereon an overlayer comprising lanthanum oxide and optionally a second support. The layer of catalyst is separate from the lanthanum oxide. The Nobel metal can include platinum, palladium, rhodium, ruthenium and iridium. The oxygen storage component can include the oxide of a metal from the group consisting of iron, nickel, cobalt and the rare earths. Illustrative of these are cerium, lanthanum, neodymium, praseodymium, etc.

U.S. Pat. No. 5,057,483 discloses a catalyst composition disposed in two discrete coats on a carrier. The first coat includes a stabilized alumina support on which a first platinum catalytic component and bulk ceria is dispersed, a bulk iron oxide, a metal oxide such as bulk nickel oxide (which is effective for the suppression of hydrogen sulfide emissions), and one or both of baria and zirconia dispersed throughout the first coat as a thermal stabilizer. The second coat, which may comprise a top coat overlying the first coat, contains a co-formed (e.g., co-precipitated) rare earth oxide-zirconia support on which a first rhodium catalytic component is dispersed, and a second activated alumina support having a second platinum catalytic component dispersed thereon. The second coat may also include a second rhodium catalytic component, and optionally, a third platinum catalytic component, dispersed as an activated alumina support.

U.S. Pat. No. 5,472,673 discloses an exhaust gas purification device for an engine. The device comprises an engine, an exhaust passage, a NOx absorbent, and a sulfur trapping means. The exhaust passage extends from an upstream end, which receives exhaust gas from the engine to a downstream end from which exhaust gas is released. The NOx absorbent is arranged in the exhaust passage wherein the NOx absorbent absorbs NOx contained in the exhaust gas when a concatenation of oxygen in the exhaust gas flowing into the NOx absorbent is above a predetermined oxygen concentration. The NOx absorbent releases the absorbed NOx when the concentration of oxygen in the exhaust gas flowing into the NOx absorbent is lower than the predetermined oxygen concentration. The sulfur trapping means is arranged in the exhaust passage upstream of the NOx absorbent for trapping SOx contained in the exhaust gas wherein the trapped SOx is not released from the sulfur trapping means when the concentration of oxygen in the exhaust gas flowing into the sulfur trapping means is lower than the predetermined oxygen concentration so that SOx is prevented from reaching and being absorbed into the NOx absorbent.

U.S. Pat. No. 5,687,565 discloses a method for reducing the concentration of carbon monoxide, organic compounds and sulfur oxides in an exhaust gas from an internal combustion engine. The method comprises (a) contacting the exhaust gas with a sulfur oxide absorbent in a first contacting zone and absorbing with the sulfur oxide absorbent at least a portion of the sulfur oxides in the exhaust gas wherein the sulfur oxide absorption is substantially irreversible at temperatures which are less than or equal to that of the exhaust gas; (b) contacting the effluent gas from the first contacting zone with a catalyst in a second contacting zone and catalyzing the conversion of at least a portion of the carbon monoxide and organic compounds in the effluent gas from the first contacting zone to innocuous products; and (c) transferring heat from the exhaust gas to the second contacting zone by indirect heat exchange.

U.S. Pat. No. 5,687,565 discloses a system for exhaust gas purification disposed in an exhaust pipe of an internal combustion engine. The system comprises a catalyst composition giving an excellent light-off performance at low temperatures, which comprises a precious metal and a substance having at least one of an electron donatability and a nitrogen dioxide absorbability and releasability, and optionally an adsorbent having hydrocarbon adsorbability.

The conventional catalysts described above employing NOx storage components have the disadvantage under practical applications of suffering from long-term activity loss because of SOx poisoning of the NOx traps. The NOx trap components employed in the catalysts tend to trap SOx and form very stable sulfates, which require extreme conditions and extract a high fuel penalty to regenerate the trapping capacity of the NOx storage component. Accordingly, it is a continuing goal to develop a three-way catalyst system, which can reversibly trap SOx present in the gaseous stream and thereby prevent SOx sulfur oxide poisoning of the NOx trap.

### SUMMARY OF THE INVENTION

The present invention relates to a method for removing NOx and SOx contaminants from a gaseous stream comprising the steps of:

(1) providing a catalyst composite comprising a downstream section and an upstream section:

(A) the downstream section comprising:

(a) a first support;

(b) a first platinum component; and

(c) a NOx sorbent component; and

(B) the upstream section comprising:

(a) a second support;

(b) a second platinum component; and

(c) a SOx sorbent component selected from the group consisting of oxides of Mg, Sr, and Ba; and

(2) in a sorbing period, passing a lean gaseous stream comprising NOx and SOx within a sorbing temperature range through the upstream section to sorb at least some of the SOx contaminants and thereby provide a SOx depleted gaseous stream exiting the upstream section and entering the downstream section, wherein the downstream section sorbs and abates the NOx in the gaseous stream and thereby provides a NOx depleted gaseous stream exiting the downstream section; and

(3) in a SOx desorbing period, converting the lean gaseous stream to a rich gaseous stream and raising the temperature of the gaseous stream to within a desorbing temperature range to thereby desorb and abate at least some of the SOx contaminants in the upstream section and thereby provide a SOx enriched gaseous stream exiting the upstream section and entering the downstream section, wherein the desorbing temperature range is sufficiently high such that the SOx contaminants are substantially not sorbed in the downstream section.

The method may further optionally include a (4) NOx desorbing period, comprising converting the lean gaseous stream to a rich gaseous stream and raising the temperature of the gaseous stream to within a desorbing temperature range to thereby reduce and desorb at least some of the NOx contaminants from the downstream section and thereby provide a NOx enriched gaseous stream exiting the downstream section.

The present invention also relates to a method of forming a catalyst composite comprising a downstream section and an upstream section which comprises the steps of:

(a) combining a water-soluble or dispersible first platinum component and a finely divided, high surface area refractory oxide NOx sorbent component with an aqueous liquid to form a first solution or dispersion, which is sufficiently dry to absorb essentially all of the liquid;

(b) forming a first layer of the first solution or dispersion on a first support;

(c) converting the first platinum component in the first layer on the first support to a water-insoluble form to form a downstream section of the catalyst composite;

(d) combining a water-soluble or dispersible second platinum component and a SOx sorbent component selected from the group consisting of oxides of Mg, Sr, and Ba with an aqueous liquid to form a second solution or dispersion, which is sufficiently dry to absorb essentially all of the liquid;

(e) forming a second layer of the second solution or dispersion on a second support; and

(f) converting the second platinum component in the second layer on the second support to a water-insoluble form to form an upstream section of the catalyst composite.

The step of converting the first platinum component may comprise calcining the first layer and the step of converting the second platinum component may comprise calcining the second layer. The method may further comprise the steps of (i) comminuting the water-insoluble, first platinum component in a first coat slurry, forming a first layer of the first slurry, and drying the first slurry; and (ii) comminuting the water-insoluble, second platinum component in a second coat slurry, forming a second layer of the second slurry on the first layer, and drying the second slurry.

The comminuting preferably provides a slurry in which most of the solids have particle sizes of less than about 10 microns. At least one of the first and second slurries may contain acetic acid or nitric acid. The first platinum component and the second platinum component may be platinum nitrate. The method may further comprise the step of forming the first layer and the second layer on a honeycomb substrate.

The present invention also relates to a catalyst composite comprising a downstream section and am upstream section:

(A) the downstream section comprising:

(a) a first support;

(b) a first platinum component; and

(c) a NOx sorbent component; and

(B) the upstream section comprising:

(a) a second support;

(b) a second platinum component; and

(c) a SOx sorbent component selected from the group consisting of oxides of Mg, Sr, and Ba.

### DETAILED DESCRIPTION OF THE INVENTION

For lean burn engine emission reduction, a NOx adsorber is generally used to reduce NOx emissions. However, NOx adsorbers are poisoned by sulfur in the exhaust gas and gradually lose their ability to reduce NOx emissions. In order to regenerate the NOx adsorbers, a high temperature desulfation treatment is required. For advanced NOx adsorbers using K and/or Cs, desulfation at 750° C. is required. Since normal exhaust temperature is 400° C., a significant amount of fuel is required to bring the exhaust temperature from 400° C. up to 750° C., to thereby enable desulfation. Thus desulfation results in a substantial penalty in fuel efficiency.

SOx trap agents can be divided into three categories according to SOx adsorption strength, using ΔG of sulfate formation at 650° C. (1). Low temperature SOx trap agents have a ΔG in the range from about 15 to about 27 kcal/mol and include transitional metal oxides such as Zn, Cu, Ni, Co, Fe, and Mn. (2). Medium temperature SOx trap agents have a ΔG in the range from about 30 to about 86 kcal/mol and include Mg, Ca, Sr, Ba, and Li. (3). High temperature SOx trap agents have a ΔG in the range from about 121 to about 149 kcal/mol and include alkali metal oxides such as Na, K, Rb, and Cs.

When SOx is trapped too strongly in a high temperature SOx trap agent, a high desulfation temperature is required to regenerate the SOx trap which may be as high as the denitration temperature of the NOx trap, and thereby defeat the purpose of SOx trap. High temperature SOx trap agents also result in a high fuel penalty. When SOx is trapped too weakly in a low temperature SOx trap agent, only a low desulfation temperature is required which results in less controlled desulfation and poisoning of the down stream NOx adsorber. Medium temperature SOx trap agents (Mg/Sr/Ba) are the best SOx trap agents because of their optimal strength of trapping SOx. At 600° C., SOx is released from the medium temperature SOx trap agent under a controlled reducing environment and readsorption of SOx by the down stream NOx adsorber is minimized. Li is not a preferred SOx trap agent because it adversely interacts with Pt/Rh and Pt/Pd/Rh catalysts rendering the three-way catalysts much less stable at high temperature, and reducing the efficiency of the three-way conversion system.

To mediate the fuel penalty associated with the desulfation step, the present invention provides a method of providing a SOx adsorber upstream of a NOx adsorber. The preferred SOx trap agents are Mg, Ca, Sr, Ba, used in a SOx adsorber catalyst containing Pt/Rh or Pt/Pd/Rh. By using Mg/Sr/Ba as the SOx trap agent, the desulfation temperature of the catalyst system can be reduced substantially and the fuel penalty associated with desulfation thereby minimized. For example, the desulfation temperature for a SOx adsorber using K as the SOx trap agent is as high as 750° C., whereas the desulfation temperature for a SOx adsorber using Ba as the SOx trap agent would be reduced to 650° C. and below 600° C. when Mg is used as the SOx trap agent.

The optimum system is an upstream SOx adsorber containing Pt/Rh or Pt/Pd/Rh and at least one SOx trap agent selected from Mg/Ca/Sr/Ba, followed by a down stream NOx adsorber containing Pt/Rh or Pt/Pd/Rh and at least one NOx trap agent selected from K/Cs/Ba. Preferably, the SOx sorbent component is MgO and the second platinum group metal component is Pt/Rh or Pt/Pd/Rh.

By using Pt/Rh or Pt/Pd/Rh in the SOx adsorber, the SOx adsorber catalyst can fully function as a three-way catalyst at high performance which is a basic feature required in a low cost system designed to meet stringent emission regulations. For example, a Pt catalyst would only convert about 50% hydrocarbon at temperatures below 500° C., after being aged at 900° C. A Pt/Rh or Pt/Pd/Rh catalyst can achieve higher hydrocarbon conversions at low temperatures such as 300° C.

The present invention is directed to a catalyst composite of the type useful as a three-way conversion catalyst (TWC). The TWC catalyst composite of the present invention simultaneously catalyzes the oxidation of hydrocarbons and carbon monoxide and the reduction of nitrogen oxides and sulfur oxides in a gas exhaust stream. The catalyst composites of the present invention have a sulfur oxide absorbing layer, which selectively and reversibly absorbs sulfur oxides over nitrogen oxides and thereby prevents sulfur oxide poisoning of the three-way conversion catalyst.

The reduction of NOx from the exhaust of lean-burn engines, such as gasoline direct injection and partial lean-burn engines, as well as from diesel engines, requires trapping and storing of NOx under lean engine operating conditions and releasing and reducing the NOx under stoichiometric or rich engine operating conditions. The lean operating cycle is typically between 1 to 3 minutes and the rich operating cycle is typically small (1 to 5 seconds) to preserve as much fuel as possible. A NOx adsorber catalyst generally must provide a NOx trap function and a catalyst function. Without wishing to be bound by a particular theory, it is believed that catalytic traps function in the following manner.

At lean engine operating conditions, the following reactions are promoted.

Oxidation of NO to NO₂

$$NO + 1 \text{/} 2 {O}_{2} {\to }^{catalyst} {NO}_{2} \qquad ( a )$$

NOx Storage as Nitrate

2NO₂+MCO₃+½ O₂→M(NO₃)₂+CO₂ (b)

Reaction (a) is typically catalyzed by metal oxides or precious metals such as platinum and/or palladium catalytic components. Reaction (b) is typically promoted by a basic NOx sorbent (MCO3), which is generally a carbonate or oxide of sodium, potassium, strontium, barium, etc. For example, when BaCO3 is the NOx sorbent (MCO3), M(NO3)2 is Ba(NO3)2.

At stoichiometric or rich engine operating conditions, the following reactions are promoted.

NOx Release

M(NO₃)₂+2CO→MCO₃+NO₂+NO+CO₂ (c)

NOx Reduction to N2

$$\begin{matrix}{NO}_{2} + CO {\to }^{catalyst} NO + {CO}_{2} & ( d ) \\ 2 NO + 2 CO {\to }^{catalyst} {N}_{2} + 2 {CO}_{2} & ( e )\end{matrix}$$

Reaction (c) releases NOx and regenerates the basic NOx sorbent (MCO3). Reactions (d) and (e) are typically catalyzed by metal oxides or precious metals such as platinum and/or palladium catalytic components. In addition to carbon monoxide in reactions (d) and (e), unburned hydrocarbon contaminants or hydrogen may also act as the reducing agent.

When SOx contaminants are present in the exhaust gaseous stream, the SOx contaminants compete with NOx and poison the basic NOx sorbents. When SOx contaminants are present in the exhaust stream, the following reactions are promoted.

Oxidation of SO₂ to SO₃

$${SO}_{2} + 1 \text{/} 2 {O}_{2} {\to }^{catalyst} {SO}_{3} \qquad ( f )$$

SOx Storage as Sulfate

SO₃+MCO3→MSO₄+CO₂ (g)

Reaction (f), like reaction (a), is typically catalyzed by metal oxides or precious metals. In reaction (g), SOx occupies sites for NOx storage in the basic NOx sorbent (MCO3) and replaces CO3 or NO3.

A catalyst adsorbs or traps NOx when the exhaust gas is lean and releases the stored NOx when the exhaust stream is rich. The released NOx is subsequently reduced to N2 over the same catalyst. The rich environment in an engine is normally realized with a rich pulse generated by either engine management or injection of reducing agents (such as fuel, or a CO or CO/H2 mixture) into the exhaust pipe. The timing and frequency of the rich pulse is determined by the NOx level emitted from the engine, the richness of the exhaust, or the concentration of the reductant in the rich pulse and the NOx conversion desired. Normally, the longer the lean period, the longer the rich pulse is needed. The need for longer rich pulse timing may be compensated by higher concentration of the reductant in the pulse. Overall, the quantity of the NOx trapped by the NOx trap should be balanced by the quantity of the reductant in the rich pulse. The lean NOx trapping and rich NOx trap regeneration are operative at normal operating temperatures (150-450° C.). Beyond this temperature window, the efficiency of the NOx trap catalyst becomes less effective.

In a sulfur containing exhaust stream, the catalyst becomes deactivated over time due to sulfur poisoning. To regenerate the sulfur-poisoned NOx trap, a rich pulse (or pulses) needs to be applied at temperatures higher than the normal operating temperature. The regeneration time of the generation depends on the sulfur level in the exhaust (or fuel sulfur level) and the length of the catalyst had exposed to the sulfur-containing stream. The quantity of the reductant added during the desulfation should counterbalance the total amount of sulfur trapped in the catalyst. Engine operability will determine whether a single long pulse or multiple short pulses are employed.

As used herein, the following terms, whether used in singular or plural form, have the meaning defined below.

The term “catalytic metal component”, or “platinum metal component”, or reference to a metal or metals comprising the same, means a catalytically effective form of the metal or metals, whether the metal or metals are present in elemental form, or as an alloy or a compound, e.g., an oxide.

The term “component” or “components” as applied to NOx sorbents means any effective NOx-trapping forms of the metals, e.g., oxygenated metal compounds such as metal hydroxides, mixed metal oxides, metal oxides or metal carbonates.

The term “dispersed”, when applied to a component dispersed onto a bulk support material, means immersing the bulk support material into a solution or other liquid suspension of the component or a precursor thereof. For example, the sorbent strontium oxide may be dispersed onto an alumina support material by soaking bulk alumina in a solution of strontium nitrate (a precursor of strontia), drying the soaked alumina particles, and heating the particles, e.g., in air at a temperature from about 450° C. to about 750° C. (calcining) to convert the strontium nitrate to strontium oxide dispersed on the alumina support materials.

The term “gaseous stream” or “exhaust gas stream” means a stream of gaseous constituents, such as the exhaust of an internal combustion engine, which may contain entrained non-gaseous components such as liquid droplets, solid particulates, and the like.

The terms “g/in3” or “g/ft3” or “g/ft3” used to describe weight per volume units describe the weight of a component per volume of catalyst or trap member including the volume attributed to void spaces such as gas-flow passages.

The term “lean” mode or operation of treatment means that the gaseous stream being treated contains more oxygen that the stoichiometric amount of oxygen needed to oxidize the entire reductants content, e.g., HC, CO and H2, of the gaseous stream.

The term “mixed metal oxide” means bimetallic or multi-metallic oxygen compounds, such as Ba2SrWO6, which are true compounds and is not intended to embrace mere mixtures of two or more individual metal oxides such as a mixture of SrO and BaO.

The term “platinum group metals” means platinum, rhodium, palladium, ruthenium, iridium, and osmium.

The term “sorb” means to effect sorption.

The term “stoichiometric/rich” mode or operation of treatment means that the gaseous stream being treated refers collectively to the stoichiometric and rich operating conditions of the gas stream.

The abbreviation “TOS” means time on stream.

The term “washcoat” has its usual meaning in the art of a thin, adherent coating of a catalytic or other material applied to a refractory carrier material, such as a honeycomb-type carrier member, which is sufficiently porous to permit the passage therethrough of the gas stream being treated.

The abbreviation “HT” stands for hydrotalcite.

In accord with the present invention, a method is provided for removing NOx and SOx contaminants from a gaseous stream. The method comprises providing a catalyst composite having a downstream section and an upstream section. The downstream section comprises a first support, a first platinum component, and a NOx sorbent component. The upstream section comprises a second support, a second platinum component, and a SOx sorbent component selected from the group consisting of oxides of Mg, Sr, and Ba. In a sorbing period, a lean gaseous stream comprising NOx and SOx is passed within a sorbing temperature range through the upstream section to sorb at least some of the SOx contaminants and thereby provide a SOx depleted gaseous stream exiting the upstream section and entering the downstream section. The downstream section sorbs and abates the NOx in the gaseous stream and thereby provides a NOx depleted gaseous stream exiting the downstream section. In a SOx desorbing period, the lean gaseous stream is converted to a rich gaseous stream and the temperature of the gaseous stream is raised to within a desorbing temperature range to thereby desorb and abate at least some of the SOx contaminants in the upstream section and thereby provide a SOx enriched gaseous stream exiting the upstream section and entering the downstream section. The desorbing temperature range is sufficiently high such that the SOx contaminants are substantially not sorbed in the downstream section. In a NOx desorbing period, the lean gaseous stream is converted to a rich gaseous stream to desorb and reduce NOx to nitrogen.

The first and second supports may be the same or different and may be compounds selected from the group consisting of silica, alumina, and titania compounds. Preferably the first and second supports are selected from the group consisting of alumina, silica, silica-alumina, alumino-silicates, alumina-zirconia, alumina-chromia, and alumina-ceria. More preferably, the first and second supports are titania or silica-aluminates. Most preferably, the first and second supports are independently titania or alumina.

The NOx sorbent component in the downstream section may be selected from the group consisting of alkaline earth metal components, alkali metal components, and rare earth metal components. Preferably, the NOx sorbent component is selected from the group consisting of oxides of calcium, strontium, and barium, oxides of potassium, sodium, lithium, and cesium, and oxides of cerium, lanthanum, praseodymium, and neodymium. The NOx sorbent component may be selected from the group consisting of oxides of calcium, strontium, and barium. The NOx sorbent component may be selected from the group consisting of oxides of potassium, sodium, lithium, and cesium. The NOx sorbent component may be selected from the group consisting of oxides of cerium, lanthanum, praseodymium, and neodymium. In a specific embodiment, the NOx sorbent component is at least one alkaline earth metal component and at least one rare earth metal component selected from the group consisting of lanthanum and neodymium.

The downstream section may further comprise a first platinum group metal component other than platinum. Preferably, the first platinum group metal component is selected from the group consisting of palladium, rhodium, ruthenium, iridium, and mixtures thereof. More preferably, the first platinum group metal component is palladium.

The upstream section may further comprise a second platinum group metal component other than platinum. Preferably, the second platinum group metal component is selected from the group consisting of palladium, rhodium, ruthenium, iridium, and mixtures thereof. More preferably, the second platinum group metal component is palladium. Most preferably, the second platinum group metal component is Pt/Rh or Pt/Pd/Rh. Preferably, the downstream section comprises at least about 1 g/ft3 of the first platinum component and the upstream section comprises at least about 1 g/ft3 of the second platinum component. The downstream section or the upstream section may further comprise a zirconium component.

As set out above, the SOx sorbent component may be selected from the group consisting of oxides of Mg, Sr, and Ba. Preferably, the SOx sorbent component is MgO.

The desorbing temperature range may be greater than about 500° C., preferably greater than about 600° C., more preferably, from about 600° C. to about 800° C., and most preferably from about 625° C. to about 750° C. The method may further comprise the step of in a NOx desorbing period, converting the lean gaseous stream to a rich gaseous stream and raising the temperature of the gaseous stream to within a desorbing temperature range to thereby reduce and desorb at least some of the NOx contaminants from the downstream section and thereby provide a NOx enriched gaseous stream exiting the downstream section. The downstream section may further comprise a downstream substrate and the upstream section may further comprise a upstream substrate.

In use, the exhaust gas stream, comprising hydrocarbons, carbon monoxide, nitrogen oxides, and sulfur oxides and which is contacted with the catalyst composite of the present invention, is alternately adjusted between lean and stoichiometric/rich operating conditions so as to provide alternating lean operating periods and stoichiometric/rich operating periods. The exhaust gas stream being treated may be selectively rendered lean or stoichiometric/rich either by adjusting the air-to-fuel ratio fed to the engine generating the exhaust or by periodically injecting a reductant into the gas stream upstream of the catalyst. Partial lean-burn engines, such as partial lean-burn gasoline engines, are designed with controls, which cause them to operate lean with brief, intermittent rich or stoichiometric conditions. In practice, the sulfur tolerant NOx trap catalyst composite absorbs in-coming SOx during a lean mode operation (100° C. to 500° C.) and desorbs SOx (regenerate) during a rich mode operation (greater than about 500° C., preferably greater than about 600° C., more preferably from about 600° C. to about 800° C., and most preferably from about 625° C. to about 750° C.). When the exhaust gas temperature returns to a lean mode operation (100° C. to 500° C.), the regenerated sulfur tolerant NOx trap catalyst composite can again selectively absorb in-coming SOx. The duration of the lean mode may be controlled so that the sulfur tolerant NOx trap catalyst composite will not be saturated with SOx.

When the composition is applied as a thin coating to a monolithic carrier substrate, the proportions of ingredients are conventionally expressed as grams of material per cubic inch (g/in3) of the catalyst and the substrate. This measure accommodates different gas flow passage cell sizes in different monolithic carrier substrates. Platinum group metal components are based on the weight of the platinum group metal.

The specific construction of the catalyst composite set out above results in an effective catalyst that reversibly traps sulfur oxide contaminants present and thereby prevents the sulfur oxide contaminants from poisoning the NOx trap catalysts for use in engines. The catalyst composite can be in the form of a self-supported article such as a pellet, and more preferably, the sulfur tolerant NOx trap catalyst composite is supported on a carrier, also referred to as a substrate, preferably a honeycomb substrate. A typical so-called honeycomb-type carrier member comprises a “brick” of material such as cordierite or the like, having a plurality of fine, gas-flow passages extending from the front portion to the rear portion of the carrier member. These fine gas-flow passages, which may number from about 100 to 900 passages or cells per square inch of face area (“cpsi”), have a catalytic trap material coated on the walls thereof.

The present invention includes a method for treating an exhaust gas stream, which comprises the step of contacting the gas stream comprising carbon monoxide and/or hydrocarbons, nitrogen oxides, and sulfur oxides with the catalyst composite set out above. The present invention also includes a method of treating an exhaust gas stream comprising the steps of contacting the stream with the catalyst composite set out above under alternating periods of lean and stoichiometric or rich operation. Contacting is carried out under conditions whereby at least some of the SOx in the exhaust gas stream is trapped in the catalytic material during the periods of lean operation and is released and reduced during the periods of stoichiometric or rich operation.

The present invention also includes a method for preparing the catalyst composite of the present invention. In a specific embodiment, the present invention pertains to a method of forming a catalyst composite comprising a downstream section and an upstream section which comprises the steps of:

(a) combining a water-soluble or dispersible first platinum component and a finely divided, high surface area refractory oxide NOx sorbent component with an aqueous liquid to form a first solution or dispersion, which is sufficiently dry to absorb essentially all of the liquid;

(b) forming a first layer of the first solution or dispersion on a first support;

(c) converting the first platinum component in the first layer on the first support to a water-insoluble form to form a downstream section of the catalyst composite;

(d) combining a water-soluble or dispersible second platinum component and a SOx sorbent component selected from the group consisting of oxides of Mg, Sr, and Ba with an aqueous liquid to form a second solution or dispersion, which is sufficiently dry to absorb essentially all of the liquid;

(e) forming a second layer of the second solution or dispersion on a second support; and

(f) converting the second platinum component in the second layer on the second support to a water-insoluble form to form an upstream section of the catalyst composite.

The sulfur tolerant catalyst composite may optionally comprise conventional components known in the art.

The sulfur tolerant NOx trap catalyst composite may optionally comprise alkaline earth metals, which are believed to stabilize the composition. The alkaline earth metal may be selected from the group consisting of magnesium, barium, calcium and strontium, preferably strontium and barium. Most preferably, the alkaline earth metal component comprises barium oxide or strontium oxide. Stabilization means that the conversion efficiency of the catalyst composition of each layer is maintained for longer period of time at elevated temperatures. Stabilized supports such as alumina and catalytic components such as Noble metals are more resistant to degradation against high temperature exposure thereby maintaining better overall conversion efficiencies. It is known from U.S. Pat. No. 4,727,052 that support materials, such as activated alumina, can be thermally stabilized to retard undesirable alumina phase transformations from gamma to alpha at elevated temperatures by the use of stabilizers or a combination of stabilizers. The alkaline earth metal can be applied in a soluble form, which upon calcining becomes the oxide. It is preferred that the soluble barium be provided as barium nitrate, barium acetate or barium hydroxide and the soluble strontium provided as strontium nitrate or strontium acetate, all of which upon calcining become the oxides.

The sulfur tolerant catalyst composite of the present invention can be made by any suitable method. A preferred method comprises forming a mixture of a solution of at least one water-soluble or dispersible, platinum component and a finely-divided, high surface area, refractory oxide which is sufficiently dry to absorb essentially all of the solution. The platinum group metal component other than platinum, when used, can be supported on the same or different refractory oxide particles as the platinum component. The supported platinum and other components are then added to water and preferably comminuted to form the first coat (layer) slurry. The supported platinum group component other than platinum may be comminuted with the supported platinum component, or separately and combined with the other components to form the coat slurry. In particularly preferred embodiments, the coat slurry is comminuted to result in substantially all of the solids having particle sizes of less than 10 micrometers in average diameter. The coat slurry can be formed into a layer and dried. The platinum component and optional platinum group metal component other than platinums in the resulting mixture in the layer are converted to a water-insoluble form chemically or by calcining. The layer is preferably calcined, preferably at a temperature of at least 250° C. Alternatively, the sulfur tolerant catalyst composite of the present composite can also be prepared by the method disclosed in U.S. Pat. No. 4,134,860 (incorporated by reference).

In order to deposit the coat slurries on a macrosized carrier, one or more comminuted slurries are applied to the carrier in any desired manner. Thus the carrier may be dipped one or more times in the slurry, with intermediate drying if desired, until the appropriate amount of slurry is on the carrier. The slurry employed in depositing the catalytically-promoting metal component-high area support composite on the carrier will often contain about 20% to 60% by weight of finely-divided solids, preferably about 25% to 55% by weight.

The sulfur tolerant catalyst composite of the present invention can be prepared and applied to a suitable substrate, preferably a metal or ceramic honeycomb carrier, or may be self-compressed. The comminuted catalytically-promoting metal component-high surface area support composite can be deposited on the carrier in a desired amount, for example, the composite may comprise about 2% to 40% by weight of the coated carrier, and is preferably about 5% to 30% by weight for a typical ceramic honeycomb structure. The composite deposited on the carrier is generally formed as a coating over most, if not all, of the surfaces of the carrier contacted. The combined structure may be dried and calcined, preferably at a temperature of at least about 250° C. but not so high as to unduly destroy the high area of the refractory oxide support, unless such is desired in a given situation.

The carriers useful for the catalysts made by this invention may be metallic in nature and be composed of one or more metals or metal alloys. The metallic carriers may be in various shapes such as corrugated sheet or in monolithic form. Preferred metallic supports include the heat-resistant, base-metal alloys, especially those in which iron is a substantial or major component. Such alloys may contain one or more of nickel, chromium, and aluminum, and the total of these metals may advantageously comprise at least about 15% by weight of the alloy, for instance, about 10% to 25% by weight of chromium, about 3% to 8% by weight of aluminum and up to about 20% by weight of nickel, say at least about 1% by weight of nickel, if any or more than a trace amount be present. The preferred alloys may contain small or trace amounts of one or more other metals such as manganese, copper, vanadium, titanium and the like. The surfaces of the metal carriers may be oxidized at quite elevated temperatures, e.g. at least about 1000° C., to improve the corrosion resistance of the alloy by forming an oxide layer on the surface of carrier which is greater in thickness and of higher surface area than that resulting from ambient temperature oxidation. The provision of the oxidized or extended surface on the alloy carrier by high temperature oxidation may enhance the adherence of the refractory oxide support and catalytically-promoting metal components to the carrier.

Any suitable carrier may be employed, such as a monolithic carrier of the type having a plurality of fine, parallel gas flow passages extending therethrough from an inlet or an outlet face of the carrier, so that the passages are open to fluid flow therethrough. The passages, which are essentially straight from their fluid inlet to their fluid outlet, are defined by walls on which the catalytic material is coated as a “washcoat” so that the gases flowing through the passages contact the catalytic material. The flow passages of the monolithic carrier are thin-walled channels, which can be of any suitable cross-sectional shape and size such as trapezoidal, rectangular, square, sinusoidal, hexagonal, oval, and circular. Such structures may contain from about 60 to about 600 or more gas inlet openings (“cells”) per square inch of cross section. The ceramic carrier may be made of any suitable refractory material, for example, cordierite, cordierite-alpha alumina, silicon nitride, zircon mullite, spodumene, alumina-silica magnesia, zircon silicate, sillimanite, magnesium silicates, zircon, petalite, alpha alumina and aluminosilicates. The metallic honeycomb may be made of a refractory metal such as a stainless steel or other suitable iron based corrosion resistant alloys.

The substrate can comprise a monolithic honeycomb comprising a plurality of parallel channels extending from the inlet to the outlet. The monolith can be selected from the group of ceramic monoliths and metallic monoliths. The honeycomb can be selected from the group comprising flow through monoliths and wall flow monoliths. Such monolithic carriers may contain up to about 700 or more flow channels (“cells”) per square inch of cross section, although far fewer may be used. For example, the carrier may have from about 60 to 600, more usually from about 200 to 400, cells per square inch (“cpsi”). The sulfur tolerant catalyst composite can be coated in layers on a monolithic substrate generally which can comprise from about 0.50 g/in3 to about 6.0 g/in3, preferably about 1.0 g/in3 to about 5.0 g/in3 of catalytic composition based on grams of composition per volume of the monolith.

The present invention includes a method comprising passing an inlet end fluid comprising an inlet end coating composition into a substrate as recited above. For the purpose of the present invention a fluid includes liquids, slurries, solutions, suspensions and the like. The aqueous liquid passes into the channel inlets and extending for at least part of the length from the inlet end toward the outlet end to form an inlet end layer coating, with at least one inlet end coating extending for only part of the length from the inlet end toward the outlet end. A vacuum is applied to the outlet end while forcing a gas stream through the channels from the inlet end after the formation of each inlet end coating without significantly changing the length of each inlet layer coating. At least one outlet end aqueous fluid comprising at least one outlet end coating composition is passed into the substrate through the at least some of the channel outlets at the substrate outlet end. The aqueous liquid passes into the channels and extending for at least part of the length from the outlet end toward the inlet end to form at least one outlet end layer coating. The method can further comprise applying a vacuum to the inlet end while forcing a gas stream through the channels from the outlet end after the formation of each outlet end coating without significantly changing the length of each outlet layer coating.

The method can further comprise the step of fixing the precious metal component selected from the inlet precious metal component of the inlet layer and the outlet precious metal component of the outlet layer to the respective inlet or outlet component selected from the inlet refractory oxide and inlet rare earth metal oxide components and the outlet refractory oxide and outlet rare earth metal oxide components. The fixing can be conducted prior to coating the inlet and outlet layers. The step of fixing can comprise chemically fixing the precious metal component on the respective refractory oxide and/or rare earth metal oxide. Alternatively, the step of fixing can comprise thermally treating the precious metal component on the respective refractory oxide and/or rare earth metal oxide. The step of fixing comprises calcining the precious metal component on the respective refractory oxide and/or rare earth metal oxide. The step of calcining can be conducted at from 200° C., preferably 250° C. to 900° C. at from 0.1 to 10 hours. The steps of thermally fixing each layer are preferably conducted after coating and prior to coating a subsequent layer. The step of thermally treating the substrate upon completion of coating all layers at from 200° C. to 400° C. at from 1 to 10 seconds. The step of calcining is preferably the substrate conducted upon completion of coating all layers. The step of calcining is conducted at from 250° C. to 900° C. at from 0.1 to 10 hours.

Preferably, the precious metal can be prefixed on the supports. Alternatively the method further comprises fixing the soluble components in the layer such as one precious metal component to one of the refractory oxide or rare earth metal oxide components, the fixing being conducted prior to coating the layers. The step of fixing can comprise chemically fixing the precious metal on the respective refractory oxide and/or rare earth metal oxide. More preferably, the step of fixing comprises thermally treating the precious metal on the refractory oxide and/or rare earth metal oxide. The step of thermally treating the substrate upon completion of coating one or more layers at from 200° C. to 400° C. at from 1 to 10, and preferably 2 to 6 seconds. The heat is provided by forcing a gas stream, preferably air which is heated to from 200° C. to 400° C. This temperature range has been found to substantially fix the soluble components such as precious metal components. The combination of flow rate and temperature of the gas stream should be sufficient to heat the coating layer and preferably, providing a minimum of heat to the underlying substrate to enable rapid cooling in the subsequent cooling step prior to application of subsequent layers. Preferably, the steps of thermally fixing each layer, preferably followed by cooling with ambient air, are conducted after coating and prior to coating a subsequent layer. The cooling step is preferably conducted using ambient air typically at from 5° C. to 40° C. at from 2 to 20, and preferably 4 to 10 seconds at a suitable flow rate. The combination of the ambient air flow rate and temperature of the gas stream should be sufficient to cool the coating layer. This method permits continuous coating of a plurality of layers on a substrate to form the above described article of the present invention. A preferred method comprises the step of fixing the precious metal component to the refractory oxide and rare earth metal oxide components, the fixing being conducted prior to coating the first and second layers.

In yet another embodiment the method comprises the step of applying a vacuum to the partially immersed substrate at an intensity and a time sufficient to draw the coating media upwardly to a predesignated distance from the bath into each of the channels to form a uniform coating profile therein for each immersion step. Optionally, and preferably the substrate can be turned over to repeat the coating process from the opposite end. The coated substrate should be thermally fixed after forming the layer.

The method can include a final calcining step. This can be conducted in an oven between coating layers or after the coating of all the layers on the substrate has been completed. The calcining can be conducted at from 250° C. to 900° C. at from 0.1 to 10 hours and preferably from 450° C. to 750° C. at from at from 0.5 to 2 hours. After the coating of all layers is complete the substrate can be calcined.

A method aspect of the present invention provides a method for treating a gas containing noxious components comprising one or more of carbon monoxide, hydrocarbons and nitrogen oxides, by converting at least some of each of the noxious components initially present to innocuous substances such as water, carbon dioxide and nitrogen. The method comprises the step of contacting the gas under conversion conditions (e.g., a temperature of about 100° C. to 950° C. of the inlet gas to the catalyst composition) with a catalyst composition as described above.

While the invention has been described in detail with respect to specific embodiments thereof, such embodiments are illustrative and the scope of the invention is defined in the appended claims.

We claim:

1. A method for removing NOx and SOx contaminants from a gaseous stream comprising the steps of:
(1) providing a catalyst composite comprising a downstream section and an upstream section:
(A) the downstream section comprising:
(a) a first support;
(b) a first platinum component; and
(c) a NOx sorbent component; and
(B) the upstream section comprising:
(a) a second support;
(b) a second platinum component; and
(c) a SOx sorbent component selected from the group consisting of oxides of Mg, Sr, and Ba; and
(2) in a sorbing period, passing a lean gaseous stream comprising NOx and SOx within a sorbing temperature range through the upstream section to sorb at least some of the SOx contaminants and thereby provide a SOx depleted gaseous stream exiting the upstream section and entering the downstream section, wherein the downstream section sorbs and abates the NOx in the gaseous stream and thereby provides a NOx depleted gaseous stream exiting the downstream section;
(3) in a SOx desorbing period, converting the lean gaseous stream to a rich gaseous stream and raising the temperature of the gaseous stream to within a desorbing temperature range to thereby desorb and abate at least some of the SOx contaminants in the upstream section and thereby provide a SOx enriched gaseous stream exiting the upstream section and entering the downstream section, wherein the desorbing temperature range is sufficiently high such that the SOx contaminants are substantially not sorbed in the downstream section; and
(4) in a NOx desorbing period, converting the lean gaseous stream to a rich gaseous stream to thereby desorb and reduce at least some of the NOx contaminants.

2. The method according to claim 1, wherein the first and second supports are compounds independently selected from the group consisting of silica, alumina, and titania compounds.

3. The method according to claim 1, wherein the first and second supports are compounds independently selected from the group consisting of alumina, silica, silica-alumina, alumino-silicates, alumina-zirconia, alumina-chromia, and alumina-ceria.

4. The method according to claim 1, wherein the first and second supports are independently titania or alumina.

5. The method according to claim 1, wherein the NOx sorbent component in the downstream section is selected from the group consisting of alkaline earth metal components, alkali metal components, and rare earth metal components.

6. The method according to claim 5, wherein the NOx sorbent component is selected from the group consisting of oxides of calcium, strontium, and barium, oxides of potassium, sodium, lithium, and cesium, and oxides of cerium, lanthanum, praseodymium, and neodymium.

7. The method according to claim 5, wherein the NOx sorbent component is selected from the group consisting of oxides of calcium, strontium, and barium.

8. The method according to claim 5, wherein the NOx sorbent component is selected from the group consisting of oxides of potassium, sodium, lithium, and cesium.

9. The method according to claim 5, wherein the NOx sorbent component is selected from the group consisting of oxides of cerium, lanthanum, praseodymium, and neodymium.

10. The method according to claim 5, wherein the NOx sorbent component is at least one alkaline earth metal component and at least one rare earth metal component selected from the group consisting of lanthanum and neodymium.

11. The method according to claim 1, wherein the downstream section further comprises a first platinum group metal component other than platinum.

12. The method according to claim 11, wherein the first platinum group metal component is selected from the group consisting of palladium, rhodium, ruthenium, iridium, and mixtures thereof.

13. The method according to claim 12, wherein the first platinum group metal component is palladium.

14. The method according to claim 1, wherein the upstream section further comprises a second platinum group metal component other than platinum.

15. The method according to claim 14, wherein the second platinum group metal component is selected from the group consisting of palladium, rhodium, ruthenium, iridium, and mixtures thereof.

16. The method according to claim 15, wherein the second platinum group metal component is Pt/Rh or Pt/Pd/Rh.

17. The method according to claim 1, wherein the downstream section comprises at least about 1 g/ft3 of the first platinum component.

18. The method according to claim 1, wherein the upstream section comprises at least about 1 g/ft3 of the second platinum component.

19. The method according to claim 1, wherein the SOx sorbent component is MgO.

20. The method according to claim 1, wherein the desorbing temperature range in (3) is greater than about 500° C.

21. The method according to claim 20, wherein the desorbing temperature range in (3) is greater than about 600° C.

22. The method according to claim 21, wherein the desorbing temperature range in (3) is from about 600° C. to about 800° C.

23 The method according to claim 22, wherein the desorbing temperature range in (3) is from about 625° C. to about 750° C.

24. The method according to claim 1, wherein the SOx sorbent component is MgO and the second platinum group metal component is Pt/Rh or Pt/Pd/Rh.

25. The method according to claim 1, wherein the downstream section further comprises a downstream substrate.

26. The method according to claim 1, wherein the upstream section further comprises a upstream substrate.

27. A method of forming a catalyst composite comprising a downstream section and an upstream section which comprises the steps of:
(a) combining a water-soluble or dispersible first platinum component and a finely divided, high surface area refractory oxide NOx sorbent component with an aqueous liquid to form a first solution or dispersion, which is sufficiently dry to absorb essentially all of the liquid;
(b) forming a first layer of the first solution or dispersion on a first support;
(c) converting the first platinum component in the first layer on the first support to a water-insoluble form to form a downstream section of the catalyst composite;
(d) combining a water-soluble or dispersible second platinum component and a SOx sorbent component selected from the group consisting of oxides of Mg, Sr, and Ba with an aqueous liquid to form a second solution or dispersion, which is sufficiently dry to absorb essentially all of the liquid;
(e) forming a second layer of the second solution or dispersion on a second support; and
(f) converting the second platinum component in the second layer on the second support to a water-insoluble form to form an upstream section of the catalyst composite.

28. The method according to claim 27, wherein the first and second supports are compounds independently selected from the group consisting of silica, alumina, and titania compounds.

30. The method according to claim 28, wherein the first and second supports are independently titania or alumina.

31. The method according to claim 27, wherein the NOx sorbent component in the downstream section is selected from the group consisting of alkaline earth metal components, alkali metal components, and rare earth metal components.

32. The method according to claim 31, wherein the NOx sorbent component is selected from the group consisting of oxides of calcium, strontium, and barium, oxides of potassium, sodium, lithium, and cesium, and oxides of cerium, lanthanum, praseodymium, and neodymium.

33. The method according to claim 27, wherein the downstream section further comprises a first platinum group metal component other than platinum.

34. The method according to claim 33, wherein the first platinum group metal component is palladium.

35. The method according to claim 27, wherein the upstream section further comprises a second platinum group metal component other than platinum.

36. The method according to claim 35, wherein the second platinum group metal component is Pt/Rh or Pt/Pd/Rh.

37. The method according to claim 27, wherein the downstream section comprises at least about 1 g/ft3 of the first platinum component.

38. The method according to claim 27, wherein the upstream section comprises at least about 1 g/ft3 of the second platinum component.

39. The method according to claim 27, wherein the SOx sorbent component is MgO.

40. The method according to claim 27, wherein the step of converting the first platinum component comprises calcining the first layer and the step of converting the second platinum component comprises calcining the second layer.

42. The method according to claim 27, further comprising the steps of:
(i) comminuting the water-insoluble, first platinum component in a first coat slurry, forming a first layer of the first slurry, and drying the first slurry; and
(ii) comminuting the water-insoluble, second platinum component in a second coat slurry, forming a second layer of the second slurry on the first layer, and drying the second slurry.

43. The method as recited claim 27, wherein the comminuting provides a slurry in which most of the solids have particle sizes of less than about 10 microns.

44. The method as recited claim 27, wherein at least one of the first and second slurries contains acetic acid or nitric acid.

45. The method according to claim 27, wherein the first platinum component and second platinum component are platinum nitrate.

46. The method according to claim 27, further comprising the step of forming the first layer and the second layer on a honeycomb substrate.

47. A catalyst composite comprising a downstream section and am upstream section:
(A) the downstream section comprising:
(a) a first support;
(b) a first platinum component; and
(c) a NOx sorbent component; and
(B) the upstream section comprising:
(a) a second support;
(b) a second platinum component; and
(c) a SOx sorbent component selected from the group consisting of oxides of Mg, Sr, and Ba.
